(19) United States
(12) Patent Application Publication
(10) Pub. No.: US 2002/0172567 A1
(43) Pub. Date: Nov. 21, 2002

(54) Cutting tool

(76) Inventor: Herbert Popke, Ebendorf (DE)

Correspondence Address: VIDAS, ARRETT & STEINKRAUS, P.A., 6109 BLUE CIRCLE DRIVE, SUITE 2000, MINNETONKA, MN, 55343-9185, US

(21) Appl. No.: 10/125,883

(22) Filed: Apr. 19, 2002

(30) Foreign Application Priority Data
May 18, 2001 (DE) 101 24 234.4

(51) Int. Cl. B23C 5/20; B26D 1/00

(52) U.S. Cl. 407/35; 407/43

(57) ABSTRACT

A rotary cutting tool with a holder body rotating about a central axis on which at least two cutting blades are mountable which have at least one cutting edge each and successively get in a metal-cutting engagement with a workpiece when the holder body rotates while simultaneously undergoing a linear forward feed, wherein the cutting blades are adapted to be advanced to a predetermined milling depth wherein the cutting edge of one cutting blade is disposed in an offset relationship from the cutting edge of the other cutting blade so that different areas of the cutting edges get into engagement with the workpiece and each cutting edge makes a partial contribution to the predetermined milling depth.

### CROSS-REFERENCE TO RELATED APPLICATIONS

Not applicable.

### STATEMENT REGARDING FEDEALLY SPONSORED RESEARCH

Not applicable.

### BACKGROUND OF THE INVENTION

This invention relates to a cutting tool according to claim 1. More specifically, the invention relates to a cutting tool having at least two cutting blades which are attached to a holder body and, while the cutting tool rotates, successively get into a chip-cutting engagement with a workpiece if the holder body undergoes a linear feed motion at the same time.

A typical example for such a cutting tool is a surface-milling cutter or cornering cutter which, for example, is loaded with reversible cutting blades. The reversible cutting blades typically are uniformly mounted on the circumference of the holder body in a predetermined pitch.

Reversible cutting blades are commonly used on such tools, but also on specific drilling tools, reamers or the like. The invention which will be explained below, however, is not limited to using reversible cutting blades although substantial reference is made thereto for the purposes of explanation.

Reversible cutting blades are commonly clamped either directly into appropriate pockets of the holder body in a known manner or use so-called cassettes which, in turn, are fixed in pockets of the holder body.

The positioning of the cutting edge relative to the axis of the holder body is of significance for the way of action of such a cutting tool, e.g. a milling cutter. The determining factors are the axial angle, the radial angle, and the setting angle. The axial angle means the relative position of a cutting blade or its edge with respect to the axis of rotation of the milling cutter body. The radial angle is the angle between the plane of the milling blade and the radius of the holder body. The setting angle is the angle which the cutting edge has with respect to the direction of the tool feed travel. All of the angles usually are unlike 90°. For obvious reasons, efforts are made not to allow the cutting edge to engage the workpiece simultaneously across the whole length of the cutting edge, but gradually while starting from one end. This minimizes the stress acting on the cutting blade and the cutting edge, and the vibrations which naturally occur because of cutting blade bumps while metal-cutting is done with several blades.

A series of parameters play a role while metal-cutting is done with the cutting tools described. The desirable feature is a large stock removal per unit time at a minimal stress of the cutting edge and a minimum of cutting force. The cutting force naturally has an effect on energy consumption during a metal-cutting operation. High stresses on the cutting edge result in short tool service lives and, hence, cause replacing operations which are time-consuming and have an impact on the entire time of manufacture. Further, the expenditure in manufacture is influenced by the different conditions in using cutting blades. In the conventional metal-cutting technique, the cutting blades are identically positioned and oriented on the holder body so that only certain areas of a cutting edge are subjected to a particular stress in most cases. As soon as the most stressed area of the cutting edge has ceased to be usable the cutting blades requires to be exchanged or reversed. The result is that the cutting blade is incompletely utilized.

It is known to achieve a dampening action by arranging the cutting blades at a differing pitch on the circumference of the holder body.

It is the object of the invention to improve a cutting tool of the generic type in a way such as to minimize the cutting force and to obtain a larger stock removal with the machine performance remaining the same. Furthermore, it is to be an object to improve the utilization of the cutting edges.

### BRIEF SUMMARY OF THE INVENTION

In the inventive cutting tool, different areas of the cutting edges get into engagement with the workpiece with each cutting edge making a partial contribution to the predetermined depth of the milling cut. The depth of the milling cut is governed by the feed travel of the cutting tool in the machine. For conventional cutting tools, the feed travel is such that the major portion gets into engagement with the workpiece across the length of the cutting edge. In the invention, on the contrary, only portions of the cutting edge of a cutting plate get into engagement each with the workpiece. Thus, for example, the two cutting blades may be disposed in parallel with, but offset from each other such that the cutting edge of the leading blade of a pair of cutting blades works up to a first milling depth and the trailing one makes the rest of the milling depth. This is considered for a single rotation only because each of the cutting blades will be trailing during every further rotation. The shares of the cutting edge portions on the total milling depth may be equal or may differ.

However, it is also imaginable to choose different setting angles of the offset cutting blades so that the angle for the trailing edge is larger than the one for the leading cutting edge (as considered for one pair each during one rotation).

It is also possible to offset the pairs of cutting blades in their angles with no distinct offset in height. In this case, only one of the two cutting blades always is largely stressed in the critical range whereas the other one is subjected to a stress across a major length in the less critical cutting edge area. Therefore, once the more stressed cutting blade is worn it may be replaced with the other one, which increases the overall service life of the two blades.

It is also possible to use the edge or cutting edge of one cutting blade as a roughing-down edge and that of the other blade as a finish-milling edge. In this case, only a small area of the length of a cutting edge is employed as a finish-cutting edge.

The inventive cutting edge either uses identical cutting blades or uses different ones, e.g. cutting blades having a straight blade and a curved blade.

The foregoing only discusses two cutting blades or a pair of cutting blades. It is understood that any number of pairs of cutting blades may be provided to ensure a division of cut in a cutting tool according to the invention. It is further possible to dispose the pairs at the same pitch or even at a different pitch to improve the vibration behaviour. Furthermore, a division of cut using more than two cutting edges may be provided, e.g. using three or even more cutting blades. The cutting blades are preferably employed in combination with cassettes as is known per se for such cutting tools. The cassettes may be designed so as to accommodate two or more cutting blades which are then offset from each other as described above.

The inventive division of cut has the advantage that a larger stock removal can be achieved at the same machine performance without causing a major harm to the cutting edges. On the contrary, the service life of the cutting blades can be enhanced on each tool if care is taken to improve the overall utilization of the cutting edge.

The invention will now be described in greater detail with reference to embodiments.

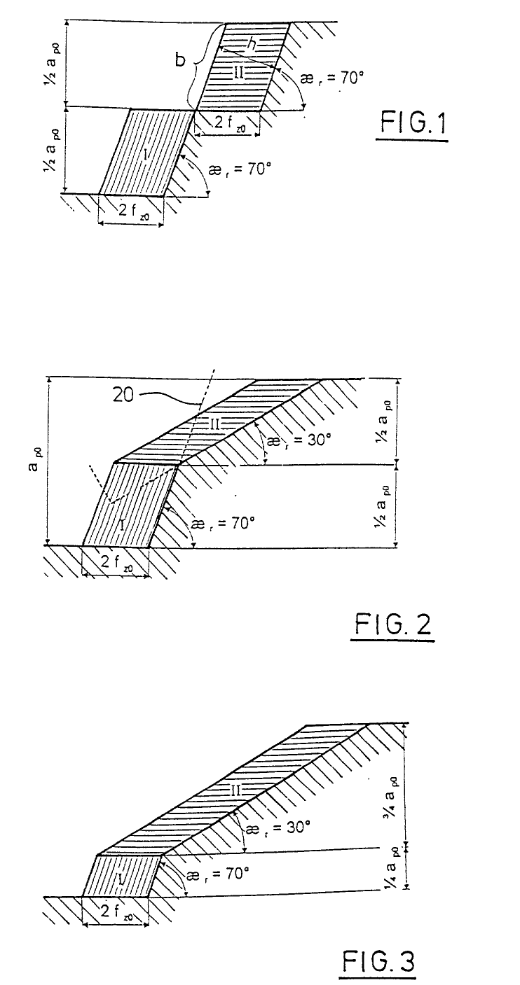

FIG. 1 schematically shows a first embodiment of an inventive division of cut.

FIG. 2 schematically shows a second embodiment of an inventive division of cut.

FIG. 3 schematically shows a third embodiment of an inventive division of cut.

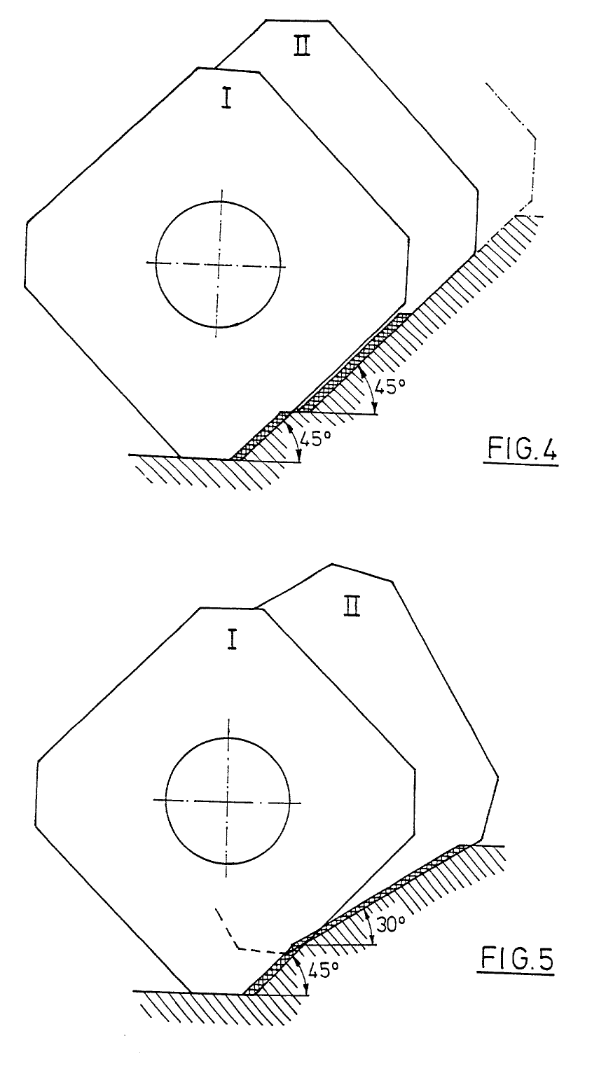

FIG. 4 schematically shows two cutting blades using a division of cut in a first embodiment.

FIG. 5 schematically shows a second embodiment of the cutting blades using another division of cut.

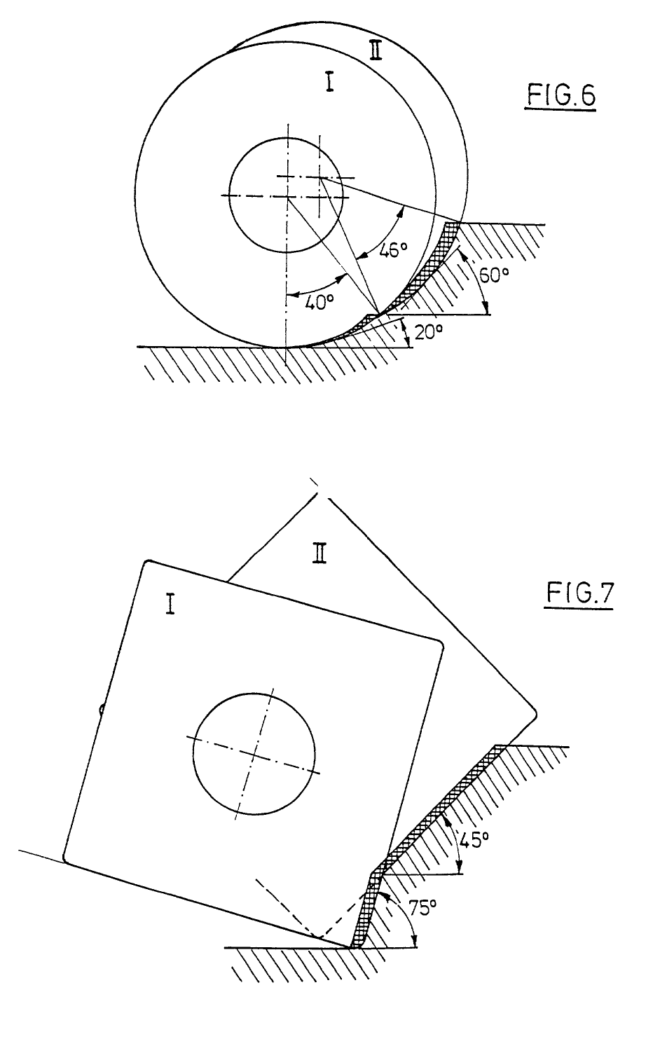

FIG. 6 schematically shows two circular cutting blades using a division of cut according to the invention.

FIG. 7 schematically shows another two exemplary cutting blades using an inventive division of cut in another embodiment.

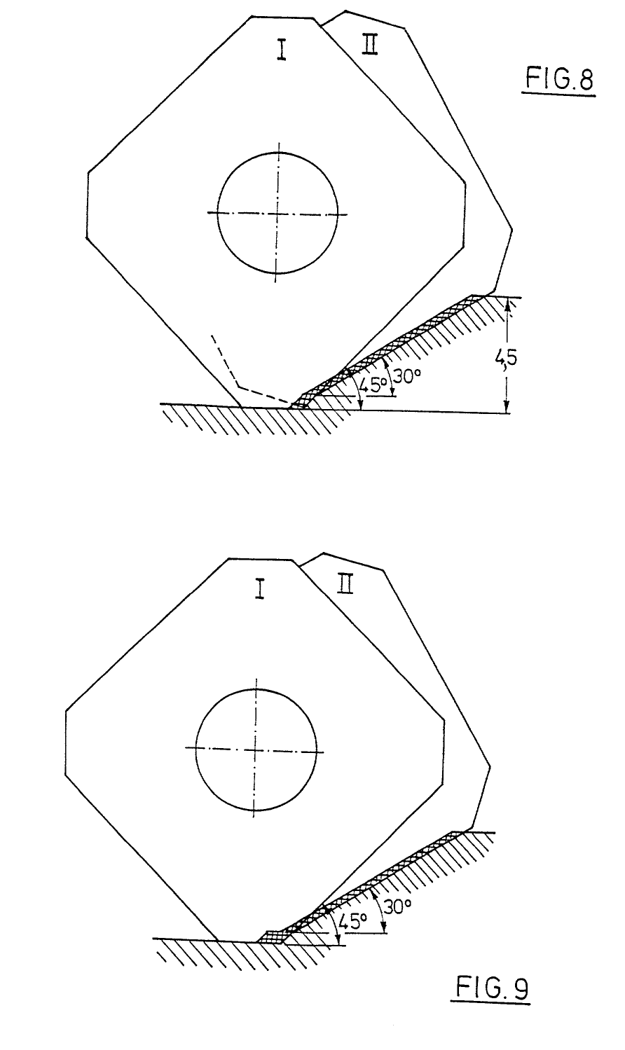

FIG. 8 schematically shows cutting blades similar to those of FIGS. 4 and 5 in a third embodiment of a division of cut.

FIG. 9 schematically shows a fourth embodiment of a division of cut using the cutting blades of FIG. 8.

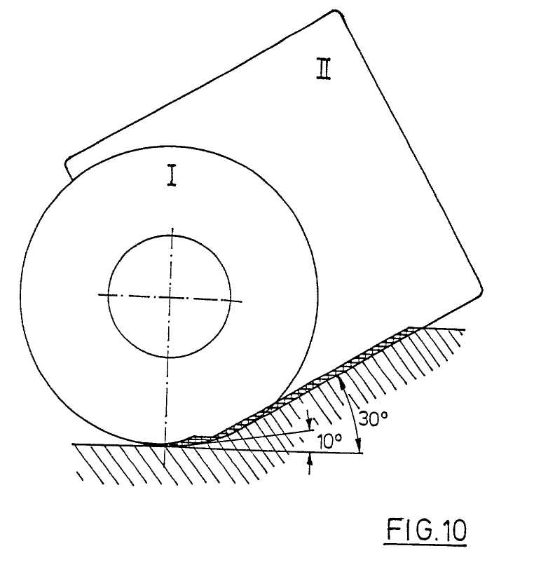

FIG. 10 schematically shows a circular cutting blade and a rectangular cutting blade which together represent another possible embodiment of a division of cut.

### DETAILED DESCRIPTION OF THE INVENTION

While the invention may be embodied in many different forms, there are described in detail herein a specific preferred embodiment of the invention. This description is an exemplification of the principles of the invention and is not intended to limit the invention to the particular embodiment illustrated.

The exemplary description which follows is based on a milling cutter in which the tool holder is rotatably chucked and, on its circumference, contains several pairs of cutting blades as are shown as examples in FIGS. 4 to 10. These pairs may be clamped on the circumference of the holder body (not shown) at a uniform pitch or a non-uniform pitch. They may be adjusted at a predetermined axial angle and/or radial angle. Detailed reference is not made thereto. These relationships are generally known as are the further angles which are of significance for metal removal, e.g. the rake angle, the clearance angle, and the respective sign of the individual angles. Only exemplary reference is made to EP 0 615 718 which depicts the fundamental set-up of such a milling cutter. In this document, the milling cutters are directly clamped in pockets of the holder body. However, an arrangement is preferably provided in so-called cassettes which, in turn, are detachably fixed in appropriate recesses or pockets of the holder body.

A pair of blades is always talked about from now with no indication being made on how many pairs are provided on a holder body. They can be fixed in the holder body by conventional means. By the way, it is also imaginable to mount three blades instead of a pair at an appropriate pitch on the circumference of the holder body. For the rest, the cutting blades may be common reversible cutting blades or may be provided with one edge or cutting edge only. No statement is made on the geometry of the cutting edge. It may be adapted to the situation that exists.

Referring to FIGS. 1 to 3, a cross-section is shown of the cutting surface of workpieces which are not further shown and which are engaged by the cutting edges of successive cutting blades while the holder body is rotating on the workpiece. The length of the surface is generally designated by b and the width is designated by h. The setting angle of the cutting blades I, II is indicated by κ=70° in FIG. 1. In the embodiment of FIG. 2, cutting blade I has a setting angle of 70° and cutting blade II has a setting angle of 30°. In the embodiment of FIG. 3, cutting blade I has a setting angle of 70° and cutting blade II has a setting angle of 30°. The general rule is that the stress acting on the cutting edge is minimal if the length b is large and the width h is small. A low cutting force is obtained as well as dynamic stability. If the setting angle is small the stress of the cutting edge will be low, e.g. for cutting blade II of FIGS. 2 and 3.

In the Figures, the depth of cut is aₚ₀ and the forward feed is f_{z0}. In FIG. 1, each one of the two blades carries out only half 2 ₐₚ₀ of the depth of cut. To reach the same stock removal as is produced by only one cutting blade having the same metal-cutting cross-section, the forward feed needs to be doubled in the embodiment of FIG. 1. As a whole, however, a lower cutting force is obtained which is about 10%, for example. In addition, vibration pulses are reduced. Since the measure h is relatively large a stable metal-cutting cross-section is obtained as well. However, the stress acting on the cutting edges of blades I and II is relatively high.

FIG. 4 shows two cutting blades I and II by which a similar division of cut is obtained as in FIG. 1 with the proportion of the cutting edges in the metal-cutting cross-section being different, however. The share of blade 1 in the milling depth is only one third of the overall milling depth whereas cutting blade II produces two thirds of the milling depth. The setting angle is 45° in FIG. 4 and is 70° in FIG. 1 as was mentioned already. In any case, it is possible to reduce the cutting force, thus achieving a larger feedstock removal while the machine performance is the same.

In the embodiment of FIG. 2, cutting blades I and II carry out one half each of the overall cutting depth, but have different setting angles, i.e. cutting blade I has an angle κ=70° and cutting blade II has an angle κ=30°. The cutting edges shown in a dashed line as is outlined at 20 represent non-used or non-stressed cutting edge portions whereas the stressed ones are shown by continuous lines. Thus, cutting blade II is not utilized in its lower cutting edge area. This area, however, normally is the one that bears most of the stress. Therefore, following a wear of cutting blade I the cutting edge of which is mainly stressed in the lower area, it is possible to exchange it by cutting blade II which still has a lower cutting edge portion which is unused. Therefore, it is possible to extend the overall service life of the cutting blades.

What should be added to FIG. 4 is that a third cutting blade is outlined by a dashed line which may interact with cutting blades I and II in a division of cut.

The embodiment of FIG. 3 is distinguished by that of FIG. 2 in that cutting blade II carries out three quarters of the milling depth aₚ₀ and cutting blade I carries out one quarter of the milling depth aₚ₀. The angular positions are those of FIG. 2.

FIG. 5 shows a somewhat more definite embodiment of FIG. 3. Though, cutting blade I has a setting angle of 45° and cutting blade II has one of 30°. The ratio of milling depths is 1:3 here.

Referring to FIG. 6, two circular cutting blades I and II are shown with a division of cut which is such that blade I produces one third and blade II produces two thirds of the milling depth. The former blade has a setting angle of 20° and the latter one has a setting angle of 60°. What was said about the advantages of such a division of cut above also applies here.

The embodiment of FIGS. 4 and 5 provides octogonal cutting blades whereas the embodiment of FIG. 7 provides square cutting blades I and II. The setting angle of cutting blade I is 75° and that of cutting blade II is 45°. The latter, in turn, essentially carries out two thirds of the milling depth whereas the former carries out one third. For the rest, there is a similarity to the embodiment of FIG. 5 with a relatively large portion of the cutting edge of blade II, however, not being used in the embodiment of FIG. 7 as is outlined by the dashed line.

FIGS. 8 and 9 show two examples that a pair of cutting blades or a plurality of pairs of cutting blades can perform both roughing-down and finish-milling. In either case, the cutting edge portion of cutting blade II is provided as a roughing-down edge and the cutting edge of cutting blade I as a finish-milling edge. As can be seen cutting blade II only contributes a very little share of the milling depth to metal removal and, therefore, is capable of relatively precise removal.

The embodiment of FIG. 10 provides a circular cutting blade I and a square cutting blade II which form a pair for a division of cut. The setting angle of the cutting edge of blade II is 30°. The cutting edge is provided for use as a roughing-down edge. The setting angle of plate I is 10°. This blade only makes a minimal contribution to metal removal and, thus, serves as a finish-milling edge.

What results from the Figures by itself with no need to re-emphasize the foregoing is that the cutting blades shown engage with a workpiece from which metal is cut. However, the workpieces are not provided with a particular reference number.

What is claimed is:

1. A rotary cutting tool with a holder body rotating about a central axis on which at least two cutting blades are mountable which have at least one cutting edge each and successively get in a metal-cutting engagement with a workpiece when the holder body rotates while simultaneously undergoing a linear forward feed, wherein the cutting blades are adapted to be advanced to a predetermined milling depth, characterized in that the cutting edge of one cutting blade (I) is disposed in an offset relationship from the cutting edge of the other cutting blade (II) so that different areas of the cutting edges get into engagement with the workpiece and each cutting edge makes a partial contribution to the predetermined milling depth (aₚ₀).

2. The cutting tool as claimed in claim 1, characterized in that the setting angles (κ) of the two cutting edges are equal.

3. The cutting tool as claimed in claim 1, characterized in that the setting angles (κ) are different.

4. The cutting tool as claimed in claim 1, characterized in that the share of the cutting blades (I, II) in the milling depth (aₚ₀) of the two cutting blades is equal.

5. The cutting tool as claimed in claim 1, characterized in that the share of the cutting blades (I, II) in the milling depth (aₚ₀) is different.

6. The cutting tool as claimed in claim 3, characterized in that the setting angle (κ) of the cutting edge producing the remaining depth is larger than that of the other cutting edge.

7. The cutting tool as claimed in claim 5, characterized in that the milling depth of the cutting edge producing the remaining depth is smaller than that of the other cutting edge.

8. The cutting tool as claimed in claim 7, characterized in that the cutting edge producing the first milling depth serves as a roughing-down edge and that of the other cutting blade serves as a finish-milling edge.

9. The cutting tool as claimed in claim 1, characterized in that the cutting blades (I, II) are of the same geometrical shape and have a straight or curved cutting edge.

10. The cutting tool as claimed in claim 1, characterized in that a first cutting blade (I) is provided which has a circular cutting edge and a second cutting blade (II) is provided which has a straight cutting edge.

11. The cutting tool as claimed in claim 10, characterized in that the cutting edge of the circular cutting blade (I) serves as a finish-milling edge.

12. The cutting tool as claimed in claim 1, characterized in that the cutting blades are reversible cutting blades.

13. The cutting tool as claimed in claim 1, characterized in that the cutting blades (I, II) are clamped in cassettes which, in turn, are chucked in the holder body.

14. The cutting tool as claimed in claim 13, characterized in that the cutting blades of a pair each are disposed in a cassette.
